(19) United States
(12) Patent Application Publication
(10) Pub. No.: US 2011/0153612 A1
(43) Pub. Date: Jun. 23, 2011

(54) SYSTEM AND METHOD FOR PROVIDING CUSTOMIZED APPLICATIONS ON DIFFERENT DEVICES

(75) Inventors: Sanjoy PAUL, Bangalore (IN); Manish JAIN, New Delhi (IN)

(73) Assignee: INFOSYS TECHNOLOGIES LIMITED, Bangalore (IN)

(21) Appl. No.: 12/785,541

(22) Filed: May 24, 2010

(30) Foreign Application Priority Data
Dec. 17, 2009 (IN) 3129/CHE/2009

(51) Int. Cl. G06F 15/173; G06F 17/30

(52) U.S. Cl. 707/740; 709/224; 707/748; 707/E17.014; 707/E17.089

(57) ABSTRACT

A method for providing a customized application on different requesting device types of a user is provided. The method enables, firstly, receiving requests made by the user using the different device types over multiple communication channels. Secondly, the method enables assigning a rank to the user based on requests received and one or more rules. Further the method enables determining personalization information based on the ranking. Finally, the method enables rendering a customized application on the different device types based on the personalization information and configuration information stored in a central data repository. The configuration information is related to the application and features thereof based on the user's subscription profile.

### FIELD OF THE INVENTION

The present invention is directed towards providing applications on different device types of a user and more specifically to a system and method for providing a customized application based on ranking of user on the basis of requests made by the user.

### BACKGROUND OF THE INVENTION

With the advent of converged networks, next generation communication service providers have started gearing up towards providing applications on various devices having different screens, such as, Television (TV), Personal Computer (PC) and mobile phone utilizing the best capabilities of each of the device types. Further, the communication service providers are transforming their network and service infrastructure to provide quadruple play (voice, video, data and mobile) to users. Previously, PC, TV and mobile phone as a medium of providing applications/services had limited capabilities. Also, on account of difference in technology of various devices, the type of applications provided across the various devices are generally different.

With device/screen convergence, both TV and mobile phone are proceeding towards being an alternate to a PC. Therefore, applications on these devices are capable of converging wherein a subscriber will be able to access an application from ‘PC at Office’, ‘mobile phone at Transit’, and ‘TV at home’. More and more users have begun to subscribe to such applications which can be rendered across various devices. Further, with emergence of Internet Protocol Television (IPTV), more and more users are subscribing to quadruple play services.

One way of achieving the above would be to maintain different repository of applications for each device type. Nowadays, this approach is being followed as a particular application is limited to be available on only one device type. However, this approach would result in maintenance chaos when a gamut of applications is to be targeted at various device types. Further, time to market will be severely hampered if each application is developed separately for each of the device types.

In light of the abovementioned disadvantages, there is a need for a system and method to render customized applications on various devices of the user based on personalization information of the user. There is also a need for a system and method that manages and controls configuration of one or more applications and features of the applications that are to be provided across various devices. Further, there is a need for a system and method to customize the user experience based upon ranking of requests made by the user.

### SUMMARY OF THE INVENTION

A method for providing a customized application on different requesting device types of a user is provided. The method comprises, firstly, receiving requests made by the user using the different device types over multiple communication channels. Secondly, the method comprises assigning a rank to the user based on requests received and one or more rules. Further the method comprises determining personalization information based on the ranking. Finally, the method comprises rendering a customized application on the different device types based on the personalization information and configuration information stored in a central data repository. The configuration information is related to the application and features thereof based on the user's subscription profile.

In an embodiment of the present invention, the method further comprises storing the requests in the central data repository. In another embodiment of the present invention, the method further comprises monitoring requests made by the user using the different device types over multiple communication channels. In an embodiment of the present invention, the multiple communication channels comprises at least one of: internet, wireless network capable of data exchange such as General Packet Radio Service (GPRS), Enhanced Data for Global Evolution (EDGE), High-Speed Packet Access (HSPA), Evolution Data Optimized (EvDO), Long-Term Evolution (LTE), Worldwide Interoperability for Microwave Access (WiMAX), Wireless Fidelity (WiFi), High Speed digital cable, Direct to Home (DTH) TV and Internet Protocol Television (IPTV) and any other type of over the air wireless network. In another embodiment of the present invention, the different requesting device types comprise at least one of: Television (TV), Mobile Phone and Personal Computer (PC). In another embodiment of the present invention, the requests comprises at least one of: browsing a website from a PC, surfing channels in a TV and making Short Messaging Service (SMS) requests using a mobile phone. In an embodiment of the present invention, the application comprises any one of a web-based application, a mobile-based application, a television-based application, gaming application etc.

In an embodiment of the present invention, the configuration information comprises information related to the application or features thereof based on user and service provider preferences. In another embodiment of the present invention, the configuration information comprises information related to reordering of application and features thereof based on user's usage information.

In an embodiment of the present invention, assigning a rank to the user based on requests received and one or more rules comprises, firstly, categorizing the requests into a plurality of interest areas. Secondly, the method comprises assigning a rank to each interest area. Finally, the method comprises incrementing the rank based on determination of the number of times requests are made corresponding to each interest area in a predetermined time period. In an embodiment of the present invention, the predetermined time period comprises requests made by the user within six hours, twelve hours, twenty four hours etc. In another embodiment of the present invention, the method further comprises tagging the user to a specific interest area.

In an embodiment of the present invention, the method further comprises, firstly, identifying access patterns of one or more users. Secondly, the method comprises determining one or more rules dynamically using machine learning techniques to classify the one or more users into one or more interest areas based on the access patterns. Finally, the method comprises assigning a rank to each user based on the classification.

In an embodiment of the present invention, identifying access patterns of one or more users comprises using information from at least one of: web server logs, TV viewing information and mobile phone usage information related to the one or more users. In another embodiment of the present invention, determining one or more rules dynamically using machine learning techniques to classify the users into one or more interest areas based on the access patterns comprises identifying users with any of similar: web server log information, TV viewing information and mobile phone usage information.

In an embodiment of the present invention, determining personalization information comprises applying predetermined rules based on the ranking to determine level of personalization of the user. In an embodiment of the present invention, rendering a customized application on the different device types based on the personalization and configuration information comprises generating a customized user interface layout.

A system for providing a customized application on different requesting device types of a user is provided. The system comprises an Adaptive Application & Feature Configuration (AAFC) module configured to facilitate maintaining configuration information related to the applications and features thereof based on the users subscription profile and further configured to rank users based on requests made by the user using different device types and one or more rules. Further, the system comprises a Service Delivery & User Interface Rendering Platform (SDUIRP) in communication with the AAFC configured to determine personalization information of the user based on the ranking and provide a customized application to the user on different requesting device types based on the personalization and configuration information.

In an embodiment of the present invention, the AAFC comprises an administrator user interface configured to receive configuration information related to the applications and features thereof and further configured to store the configuration information in a central data repository. In another embodiment of the present invention, the AAFC comprises a user profile module configured to receive and process requests made by the user using the different device types and further configured to store the request in a central data repository.

In an embodiment of the present invention, the AAFC comprises a ranking engine configured to categorize the requests into a plurality of interest areas, assign a rank to each interest area and increment the rank based on determination of the number of times requests are made corresponding to each interest area in a predetermined time period. In an embodiment of the present invention, the predetermined time comprises requests made by the user within six hours, twelve hours, twenty four hours etc.

In another embodiment of the present invention, the AAFC comprises a ranking engine which further comprises a smart analytics engine configured to facilitate the ranking engine to identify access patterns of one or more users. Further, the smart analytics engine is configured to determine one or more rules dynamically using machine learning techniques to classify the users into one or more interest areas based on the access patterns. Furthermore, the smart analytics engine is configured to assign a rank to each user based on the classification.

In an embodiment of the present invention, the AAFC comprises a ranking engine which further comprises a smart analytics engine configured to facilitate the ranking engine to analyze one or more user requests across the different device types at predetermined intervals of time. Further, the smart analytics engine is configured to add new interest areas to an existing list of interest areas dynamically using machine learning techniques for classifying similar users from amongst the one or more users into the new interest areas based on the analysis. Furthermore, the smart analytics engine assigns a rank to each user based on the classification. In an embodiment of the present invention, the one or more users correspond to any of existing users and new users.

In an embodiment of the present invention, the smart analytics engine is further configured to refine one or more fixed broad interest areas into specific interest areas or merge one or more fixed specific interest areas into one or more broad interest areas based on the analysis. In another embodiment of the present invention, the smart analytics engine is further configured to analyze one or more user requests across the different device types of the one or more users and classify similar users from amongst the one or more users into one or more fixed interest areas.

In an embodiment of the present invention, the SDUIRP is further configured to monitor the requests made by the user over multiple communication channels; and transmit the requests to the AAFC. In an embodiment of the present invention, the SDUIRP is further configured to provide information related to the user and the type of requesting device to the AAFC. In another embodiment of the present invention, the system further comprises an applications module configured to send the configuration information to the AAFC electronically in an XML file.

In another embodiment of the present invention, the system further comprises a business logic layer configured to facilitate the SDUIRP to retrieve the configuration information and ranking information from a central data repository.

The present invention is described by way of embodiments illustrated in the accompanying drawings wherein:

### BRIEF DESCRIPTION OF THE ACCOMPANYING DRAWINGS

FIG. 1 is a block diagram of a system that facilitates rendering of multiple applications on multiple device types of a user in accordance with an embodiment of the present invention;

FIG. 2 illustrates a detailed block diagram of the system that facilitates rendering of multiple applications on multiple device types of a user in accordance with an embodiment of the present invention;

FIG. 3 is a table illustrating assignment of ranks to interest areas of a user in accordance with an embodiment of the present invention;

FIG. 4 is a table illustrating static mapping of applications or features in the applications in accordance with an embodiment of the present invention;

FIG. 5 is a table illustrating static mapping of applications or features in the applications according to user type in accordance with an embodiment of the present invention;

FIG. 6 is a schematic block diagram that illustrates rendering of applications/features in the applications as per the mapping illustrated in FIG. 4 and FIG. 5; and

FIG. 7 is a flowchart illustrating a method of providing customized application on different requesting device types of the user in accordance with an embodiment of the present invention.

### DETAILED DESCRIPTION OF THE INVENTION

A method and system for rendering multiple applications on multiple device types of a user is described herein. The invention provides for a system and method that renders customized applications as per device type and static and dynamic profile of the user. The invention provides levels of personalization to user interface of the applications by tracking user's requests for different applications. The invention also provides for configuration of the applications and features of the application based on the service provider and user's preferences and user's past requests.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

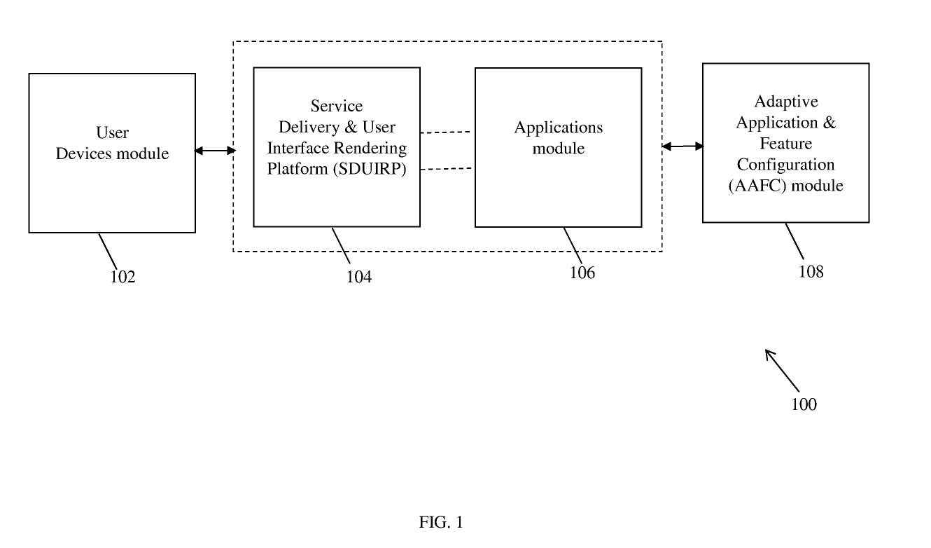

FIG. 1 is a block diagram illustrating a system 100 that facilitates rendering of multiple applications on multiple device types of a user in accordance with an embodiment of the present invention. In various embodiments of the present invention, the system 100 comprises a user devices module 102, a Service Delivery& User Interface Rendering Platform (SDUIRP) 104, an applications module 106 and an Adaptive Application & Feature Configuration (AAFC) module 108.

The user devices module 102 comprises one or more electronic communication devices which may be used by one or more user to request access to applications or services using multiple communication channels. For example, the user devices module 102 include one or more devices of multiple device types such as TV, PC, mobile phones which are used by the user to request for applications using multiple communication channels. Examples of multiple communication channels may include internet, wireless network capable of data exchange such as General Packet Radio Service (GPRS), Enhanced Data for Global Evolution (EDGE), High-Speed Packet Access (HSPA), Evolution Data Optimized (EvDO), Long-Term Evolution (LTE), Worldwide Interoperability for Microwave Access (WiMAX), Wireless Fidelity (WiFi), High Speed digital cable, Direct to Home (DTH) TV, IPTV and any other type of over the air wireless network. Examples of devices may include desktop or laptop with access to internet, high end mobile devices capable of exchanging data, Open Cable Application Platform (OCAP)/Enhanced TV Binary Interchange Format (EBIF) based digital cable TV, Direct to Home (DTH) TV and any IPTV based system. Examples of mobile devices may include cellular phones, such as, High-Tech Computer Corporation (HTC) phones, Nokia N95, Blackberry, Personal Digital Assistants (PDA), Enterprise Digital Assistants (EDA) and any other handheld computing devices. Examples of multiple applications may be a web-based application, a mobile-based application, a television-based application, gaming application etc.

In various embodiments of the present invention, the user devices module 102 facilitates the user to access a particular application offered by a communication service provider. The application may include, but not limited to, banking application, social networking application, mobile rental service application news update service application, local updates in the form of Really Simple Syndication (RSS) feeds, Atom based feeds and any other web-based, mobile-based and television-based applications. The user devices module 102 accesses various applications using the SDUIRP 104.

The SDUIRP 104 is a computing platform which caters to applications from multiple communication channels. In various embodiments of the present invention, the SDUIRP 104 is a computing platform that collectively monitors requests from various device types and corresponding profiles/subscription of the user. The SDUIRP 104 interfaces between the user devices module 102, the applications module 106 and the AAFC module 108 to facilitate generating and rendering a user interface layout for a particular application on all the device types of the user devices module 102. The SDUIRP 104 renders customized and contextually relevant user experience on the user devices module 102 based on the requests maded by the user devices module 102 for various applications.

The applications module 106 represents various application owners/service providers of the applications requested by the user devices module 102. The service providers provide services/applications to the users based on service level agreements which include user preferences and also certain service provider preferences. In various embodiments of the present invention, the service providers may include mobile telephony service providers, television service providers, internet service providers and any other communication service providers. The applications module 106 provides relevant information to the AAFC module 108 which is established for rendering multitude of applications on the user devices module 102. The information may include user or service provider preferences relating to application and features in the applications apart from the user subscription profile.

The AAFC module 108 is a computing module which facilitates processing and maintaining data/information to facilitate configuration and personalization of multitude of applications that are to be rendered on the user devices module 102. In an embodiment of the present invention, the AAFC module 108 receives data/information pertaining to parameters, such as, application, feature in the application, device type, user profile/subscription from the SDUIRP 104 and the applications module 106. The AAFC module 108 further processes the five variables and maintains mapping information amongst the five variables. The AAFC module 108, thus, facilitates generation of a user interface layout by the SDUIRP 106 for rendering the same application on different devices types of the user devices module 102.

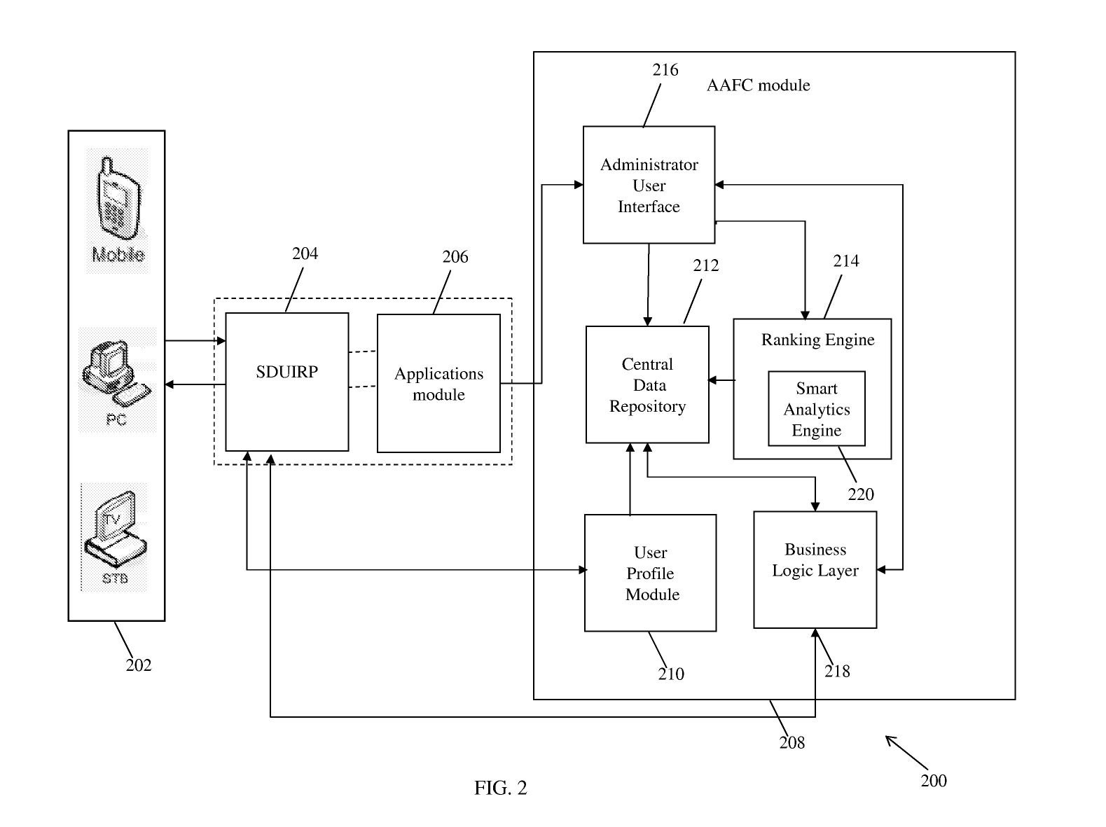

FIG. 2 illustrates a detailed block diagram of the system 200 that facilitates rendering of multiple applications on various device types of a user in accordance with an embodiment of the present invention. In various embodiments of the present invention, the system 200 comprises the user devices module 202, the SDUIRP 204, the applications module 206 and the AAFC module 208. The AAFC module 208 further comprises the user profile module 210, the central data repository 212, the ranking engine 214, the administrator user interface 216, and the business logic layer 218. In various embodiments of the present invention, the ranking engine 214 may comprise a smart analytics engine 220.

In an embodiment of the present invention, the user devices module 202 comprises various device types, such as, a mobile phone, a PC and a TV. Further, the mobile phone may include different devices, such as, HTC, Nokia N95, the PC may be hosting an internet explorer browser and the TV having an STB having Microsoft Mediaroom as client. The user possesses a separate subscription/profile specific to the various device types. Using the abovementioned device types, the user makes request for several applications or services that are offered by the applications module 206. For example, when the user browses web pages using the PC, the Uniform Resource Locator (URL) from the web browser in the PC serves as a request. Similarly, Short Messaging Service (SMS) requests made by the user using the mobile phone and channels viewed by the user using the TV serve as requests. In an embodiment of the present invention, the various device types send the respective requests in the form of Hyper Text Transfer Protocol (HTTP) requests to the SDUIRP 204.

The SDUIRP 204 receives the HTTP requests and sends the requests to the AAFC module 208 for further processing and storing of the processed information. Further, the SDUIRP 204 uses the stored information in the AAFC module 208 to define a customized user interface layout across the various device types. In an embodiment of the present invention, the SDUIRP 204 monitors the multiple communication channels collectively and receives the HTTP requests from the various device types. The SDUIRP 204 comprises components and subsystems (not shown) to construct an Extensible Hyper Text Markup Language (XHTML) web page information by capturing data encapsulated in the respective HTTP requests. The information may include, but is not limited to, user ID, device type, application, and feature in the application, date and time of the requests. The above information may be referred as dynamic information/profile of the user as it is retrieved by tracking the requests made by the user. In another embodiment of the present invention, the SDUIRP 204 provides the XHTML web page information to the user profile module 210 in the AAFC 208.

The user profile module 210 is a software module which processes the XHTML web page information and stores the same in the central data repository 212. In an embodiment of the present invention, the central data repository 212 may be a relational database management system, such as, Oracle, SQL, etc. The user profile module 210 populates the central data repository 212 with dynamic profile of the user as provided by the SDUIRP 204. For example, the user may be initiating SMS request for cricket scores, watching world cup finals video on TV and browsing ESPN web page on PC. The user profile module 210 processes the information in the request as received from the SDUIRP 204 and stores it in the central data repository 212 as dynamic profile of the user.

The ranking engine 214 is a software module which facilitates analyzing requests made by the users and assigning rank to the users based on the analysis. In an embodiment of the present invention, the ranking engine 214 is configured to analyze the dynamic profile of the user stored in the central data repository 212 using predetermined rules. In an embodiment of the present invention, the predetermined rule may comprise segregating the information into different interest areas. In the abovementioned embodiment of the present invention, the interest areas may be referred as static or fixed categories. Further, the ranking engine 214 assigns an interest level of users to the interest areas. The interest level is defined as a rank. The ranking engine 214 assigns a rank based on predetermined criteria which may be customizable. The predetermined criteria may be increasing the rank by one for each request received corresponding to an interest area from the same user in six hours, twelve hours, twenty four hours etc.

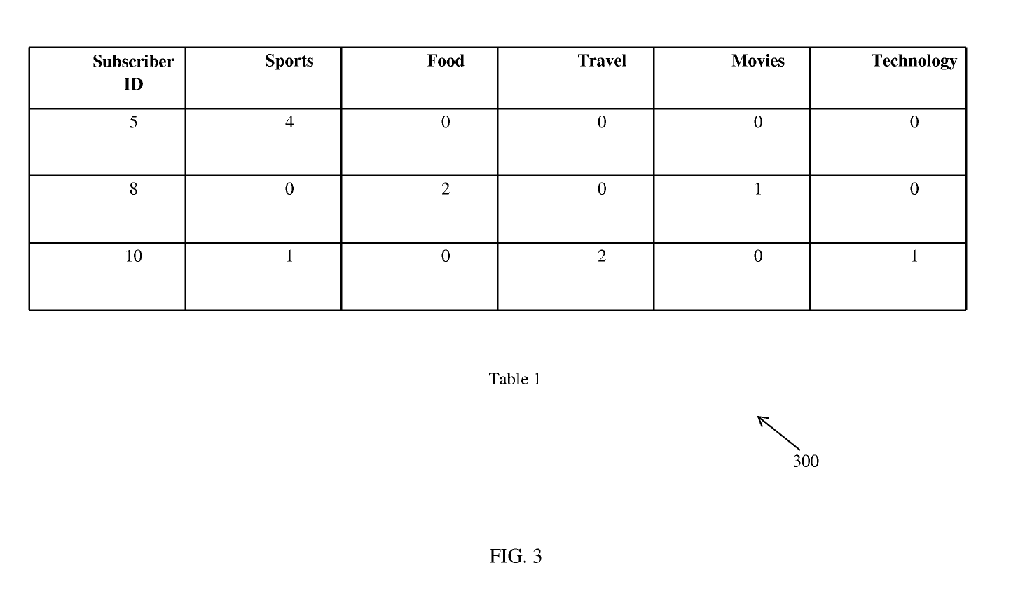

For example, as shown in FIG. 3, if a user with Id=5 watches “Olympic finals of men's singles badminton match” video on TV, requests for cricket and football scores by sending sms to a certain phone number from his mobile phone, and browses www.espn.com from his PC to read about United States open tennis scores, all within a day (24 hours), the ranking for such a user may be as shown in table 1.

If a subscriber with Id=8 watches movies on TV, requests for recipes from his TV, and requests for location of nearest Italian restaurant by sending sms to a certain phone number from his mobile phone, all within a day (24 hours), the ranking for such a user may be as shown in table 1.

If a subscriber with Id=10 requests for latest travel deals to Bahamas from his TV, searches for hotels on the world wide web from his PC, watches videos recording of “Argentina Vs Brazil” football match played last night from his TV, browses the world wide web technology news, all within a day (24 hours), the ranking for such a user may be as shown in table 1.

In an embodiment of the present invention, the ranking engine 214 uses keyword based search in the central data repository 212 to find requests from a user corresponding to a particular interest area. Based upon the search results it adjusts the rank of the user for that particular area.

In another embodiment of the present invention, the ranking engine 214 comprises a smart analytics engine 220. The smart analytics engine 220 facilitates the ranking engine 214 to identify access patterns of different users and then determine one or more rules dynamically for classifying users into interest areas which are defined on the basis of the access patterns. In the abovementioned embodiment of the present invention, the interest areas may be referred as dynamic categories. In an exemplary embodiment of the present invention, the process of identifying user access patterns may comprise pre-processing involving data cleansing, pattern discovery involving classification, and pattern analysis involving clustering of information. In various embodiments of the present invention, a rule for classifying users may include grouping similar users. The rule for grouping similar users may be determined automatically by the smart analytics engine 220. Ranking of users for a particular interest area may then be performed by the ranking engine 214 based on the grouping. The ranking information may then be stored in the central data repository 212.

In an embodiment of the present invention, the smart analytics engine 220 may be a machine language based system which facilitates the ranking engine 214 to classify and rank the users based upon the user's access patterns. The smart analytics engine 220 uses techniques rather than user-created rules to extract knowledge or identify patterns from texts. Examples of machine learning techniques may include, support vector machines, neural networks and decision trees. In an embodiment of the present invention, the classifications may subsist for a short time interval.

In an embodiment of the present invention, the user access patterns may be determined using information from web server logs which comprises history of web searches conducted by users. In another embodiment of the present invention, the user access patterns may be determined using user's pattern of TV viewing. In another embodiment of the present invention, the user access patterns may be determined using users mobile phone usage information. For example, if user watches ‘ESPN’ on TV daily or has subscribed to an SMS service for his mobile phone to receive cricket scores, the user may be identified as a sports-enthusiast.

In an exemplary embodiment of the present invention, the smart analytics engine 220 may consolidate the information in the web server logs to identify users who have accessed similar web pages. The users are, then, considered as having similar interests (similar users) and an interest area may be defined for such similar users. For example, web server logs may comprise information related to multiple users accessing information about a new mobile phone which a mobile phone company may be advertising. The smart analytics engine 220 identifies the access pattern and classifies such users into a new interest area. Further, the smart analytics engine 220 facilitates the ranking engine 214 to rank the interest areas of the users.

In an embodiment of the present invention, the smart analytics engine 220 may consolidate information related to pets in the web server logs to identify users who have accessed web pages related to pets frequently or have purchased products such as pet foods, dog collar etc. Further, the smart analytics engine 220 may consolidate information related to pets by analyzing SMS services which users subscribe related to pets e.g. dog shows in the neighborhood etc. The identified users may then be grouped into an interest area defined as “pet owners”. Further, the smart analytics engine 220 facilitates the ranking engine 214 to rank the interest areas of the users. In various embodiments of the present invention, ranking may be performed employing any suitable procedure.

In another embodiment of the present invention, the smart analytics engine 220 may transform the existing static or fixed interest areas (e.g. “sports-enthusiast”, “food enthusiast”) into dynamic interest areas. The smart analytics engine 220 may analyze behavior of users across multiple devices on a periodic basis. For example, the smart analytics engine 220 may track new users/subscribers. In another example, the smart analytics engine 220 may track behavior of the existing users over a period of time. On the basis of the above, in one embodiment, the smart analytics engine 220 may further refine the broad static or fixed interest areas into specific interest areas e.g. “cricket enthusiast”, “pizza enthusiast” etc. In another embodiment of the present invention, the smart analytics engine 220 may eliminate some of the existing static or fixed interest areas. In another embodiment of the present invention, existing specific interest areas may be merged into a broader interest area based on analyzing user behavior across multiple devices over a period of time (e.g. “cricket enthusiast”, “football enthusiast” into “sports enthusiast”). In another embodiment of the present invention, the smart analytics engine 220 may add new interest areas to an existing list of interest areas. For example, the interest area of “pet owners” may not exist in the beginning but later based on classification of users using techniques such as support vector machine, the interest area “pet owners” may be added to the existing list.

In an embodiment of the present invention, the smart analytics engine 220 may analyze behavior of users across multiple devices and classify them into one or more existing static or fixed interest areas (such as, sports-enthusiast, movie-enthusiast etc.).

The ranking engine 214 facilitates the SDUIRP 204 to determine level of personalization for defining user interface layout for a particular application to be rendered on the various device types. The SDUIRP 204 determines personalization level based on a set of predetermined rules which may reside as a program file in the SDUIRP 204 wherein the rules may be configured dynamically.

Example of rules for determining personalization of a user based upon ranking may include the following: Rank=2 may imply that the user is interested in the topic and can be targeted for buying subscription to a package containing more information on the topic. Rank=3 may imply that in addition to everything that can be done for rank=2, features and applications may be reordered so as to ease the user's access. Rank=4 may imply that in addition to everything that can be done for rank=3, the user may be identified as having passion for information relating to certain topic and so the user experience may be defined in a manner that makes the user access related information with least possible browsing.

Further, the central data repository 212 stores static profile of the user received from the administrator user interface 216. In an embodiment of the present invention, the static profile constitutes configuration information pertaining to applications and features in the applications that are to be rendered on the user devices module 202. The configuration information is predetermined by the applications module 206 based on the user's subscription profile.

In an embodiment of the present invention, the applications module 206 represents communication service providers/application owners that offers quadraple play services i.e. television, broadband, fixed and mobile telephony to users. Various service providers provide a detailed listing of features offered by a particular application along with preferred device type on which the features are to be made available to the administrator user interface 212. The listing is based on user's subscription profile comprising user preferences i.e. premium/non-premium and also service provider preferences. The preferences, for example, may include, information regarding the order in which applications for a premium user should appear as opposed to a non-premium user and certain applications/features in an application which may not be shown to non-premium subscribers. In an instance, for a bank application on TV and mobile phone, the service provider may prefer to provide ‘pay bills’ features on TV rather than mobile phone of the user. Similarly, for a social networking application, the service provider may prefer to provide voice chat feature only to PC and restrict it for TV and mobile phone.

In an embodiment of the present invention, the administrator user interface 212 may receive the configuration information electronically i.e. from the applications module 206 in an XML file in a compatible format. In an alternate embodiment, the administrator user interface 212 may receive the configuration information manually i.e. an application owner may send an excel sheet to an administrator, who in turn can manually enter the configuration information using the administrator user interface 212.

In an embodiment of the present invention, the administrator user interface 212 facilitates the administrator to validate the configuration information and/or perform any corrections thereto as per requirement. In yet another embodiment of the present invention, the administrator user interface 212 may facilitate the application owners to add, modify, and delete certain feature or make certain features/applications available/unavailable on various device types. The administrator user interface 212, thus, populates the central data repository 212 with the configuration information as static profile of the user.

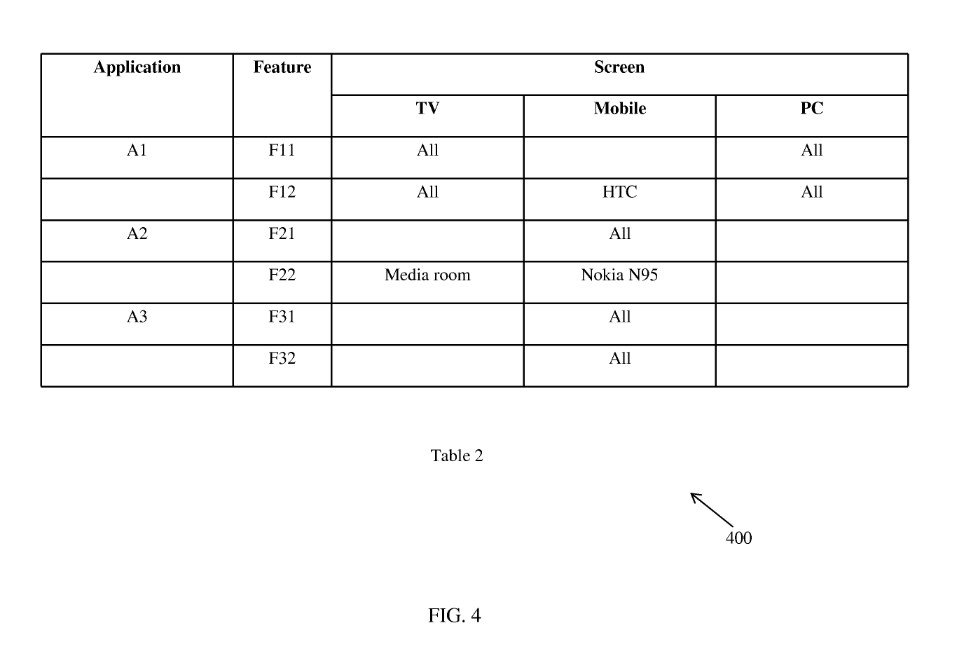

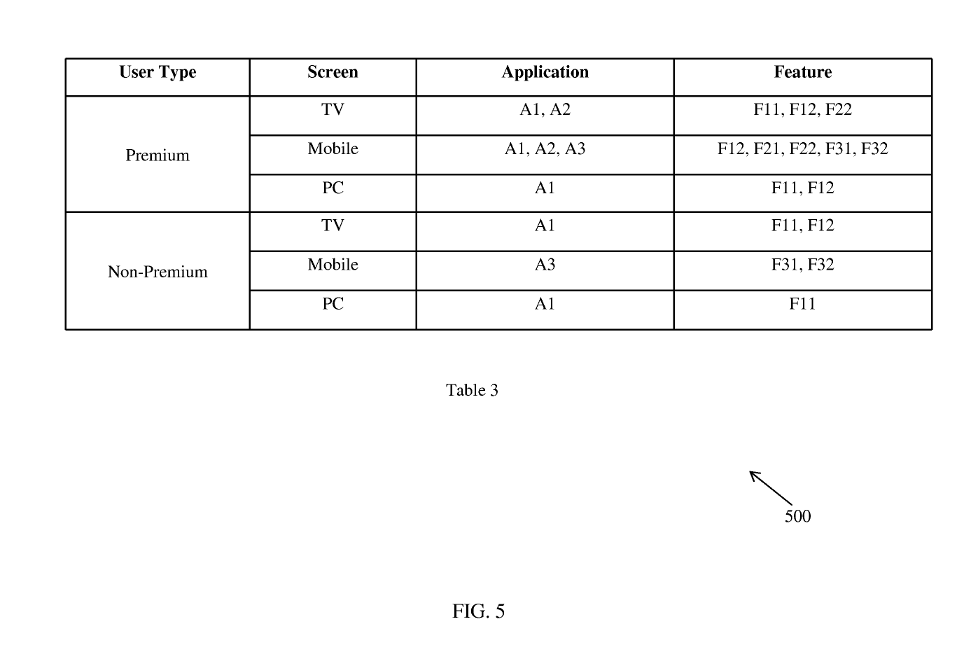

FIGS. 4 and 5 show tables 2 and 3 which depicts an example of applications and features inside applications segmented based on device/user type (i.e. premium or non premium) using the static profile in the central data repository 214.

In this example, Ai is an application developed for TV, mobile phone, and PC and Fij is a feature where j is available in an application Ai. The tables shows sample static data that is mapped for three applications viz: A1, A2, and A3 and the respective features vis-à-vis TV, mobile phone and PC and the user type. For TV, one of the devices is having Microsoft Mediaroom as client, and two mobile phone devices, HTC and Nokia N95, are shown.

Referring to FIG. 2, in an embodiment of the present invention, the SDUIRP 204 fetches the static profile (i.e. configuration information) and dynamic profile (i.e. ranking based on past requests) of the user from the central data repository 212 using the business logic layer 218. The business logic layer 218 is a web service which provides a wrapper around the AAFC module 208 so that modules outside the AAFC module 208 can query for certain information. The business logic layer 218 is configured to facilitate storing and retrieving configuration information to and from the central data repository 212.

The SDUIRP 204 uses the static and dynamic profile of the user as stored in the central data repository 212 to construct a user interface layout to provide a customized user experience to the user across various device types, thereby providing configuration and personalization of a multitude of applications.

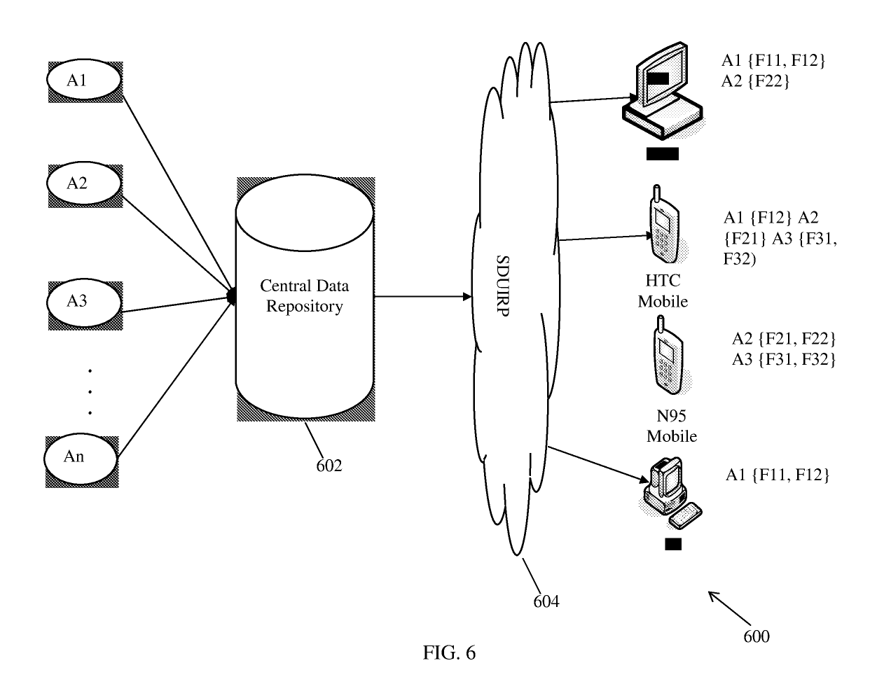

FIG. 6 is an exemplary schematic representation of the applications and features in the application that are serviced on the TV, PC and mobile phone of a user based on the static mapping (as discussed in FIGS. 4 and 5) information stored in the central data repository 602. As shown, the SDUIRP 604 renders user customized interface on TV, mobile phone and PC in accordance with usage on various devices.

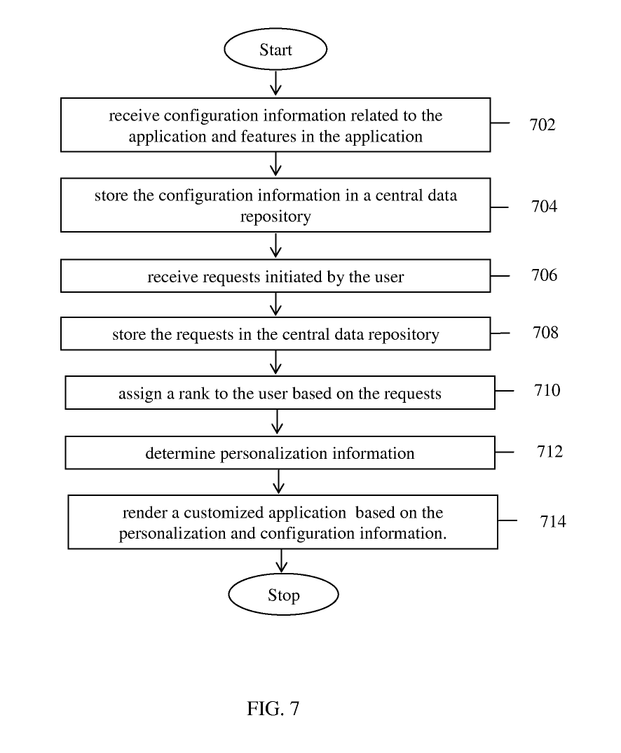

FIG. 7 is a flowchart illustrating a method of providing customized applications to different requesting device types of a user in accordance with an embodiment of the present invention.

At step 702, configuration information related to the application and features of the application is received. In various embodiments of the present invention, applications and/or features inside the application are configured based on user's subscription profile. The user's subscription profile indicates, for example, if a user is a premium/non premium user and also service provider's preferences of permitting/restricting a particular application or feature thereof on different devices of a user. Examples of applications may be banking applications, social networking applications, news update applications etc.

Embodiments of the present invention, thus, enable fine granular control over a feature set of an application visible on the various devices of the user. For example, some of the features can be made accessible to all users, while some features are only accessible to premium users. Further, for example, in case of a banking application, the ‘pay bill’ feature may be permitted only on TV and blocked on mobile phone and PC. In a social networking application the ‘voice chat’ feature may be permitted only on PC and blocked on mobile phone and TV. Thus, embodiments of the present invention enable access to features in the application based on what is to be shown on various device types.

In a further embodiment of the present invention, configuring applications and the features inside the application comprises reordering the applications and/or the features to make the offering on a device more meaningful to the user. Certain applications and features may be placed at the top of the list, if the user is found to use these applications and features more frequently than other users. Such applications and features may be placed at the bottom of the list for another user depending on his frequency of usage. Thus, same applications and features would be placed differently based on user behavior. Such a reordering facilitates users to access mostly used features/applications with less browsing. For example, if a user uses TV more often than mobile phone for accessing a banking application, then banking application on TV would be placed higher in the list than banking application on the mobile phone.

At step 704, the configuration information is stored in a central data repository. In various embodiments of the present invention, the configuration information is stored in the central data repository as static profile of the user. In an example, the static profile of the user provides information, such as, what applications should be shown on TV for user with a certain Identification (ID), what features of banking application should be shown on Nokia N95 etc.

At step 706, requests made by a user are received. In various embodiments of the present invention, multiple communication channels through which requests from various devices types are made by the user are collectively monitored. The requests may include browsing a website from a PC, surfing channels in a TV and making SMS requests using a mobile phone. The requests can, thus, be dynamically tracked and are indicative of user's interest area and user activity. In an embodiment of the present invention, the request is processed and information is extracted from the request. The information in the request includes, user details, such as, subscriber ID, device type (e.g. TV, PC and mobile phone, HTC, Nokia N95, set top box with Microsoft Mediaroom as client etc.) and data and time of the request. In a further embodiment of the present invention, the request includes information indicative of various applications and features of applications which the user accesses across the various devices. The information may be identified as interest area of the user. The user may, then, be tagged to a particular interest area.

At step 708, requests are stored in the central data repository. In various embodiments of the present invention, the information from the request is stored as dynamic profile of the user in the central data repository. The information is divided into various categories related to different interest areas of the user. In an embodiment of the present invention, the information stored in the central data repository is analyzed to identify the interest area, such as, sports, food, books etc., and is categorized accordingly. The interest area is identifiable based on the various applications the user accesses. For example, if the user browses a sports site using his PC, sports is identified as the user's interest area. If the user sends an SMS request pertaining to a food item using his mobile phone, food is identified as his interest area.

At step 710, a rank is assigned to the user based on the requests. In an embodiment of the present invention, ranking of the interest areas is triggered to identify the level of interest of the user for each interest area based on the requests made. For example, if the request indicates sports as the interest area, 1 may be assigned to the interest area ‘sports’ against the user's ID in the central data repository. In another example, if the request from the same subscriber indicates ‘food’, 1 may be assigned to the interest area ‘food’ against the user's ID in the central data repository. In a further embodiment of the present invention, the rank is incremented when request corresponding to each interest area is tracked within a predetermined time. In an embodiment of the present invention, the rank which is assigned to a particular interest area of the user is incremented by 1 based on predetermined criteria. In an exemplary embodiment of the present invention, the predetermined criteria may be the number of times the user is found to make a request corresponding to that interest area. For example, if the user requests for information related to ‘sports’ from TV, PC, and mobile phone, within 24 hours, the assigned rank 1 to ‘sports’ is incremented to 4. In another example, if the user requests for information related to food from TV but not from PC and mobile phone within 24 hours, the assigned rank 1 to ‘food’ is incremented to 2.

In another embodiment of the present invention, access patterns of one or more of the users are identified. The access patterns of the users may comprise identifying user's web server logs, TV viewing information and mobile phone usage information. On the basis of the access patterns new interest areas may be defined. For example, if users are found to access pet related sites using PC, make SMS requests related to pets, a new interest area “pet owners” may be defined. One or more rules are then determined dynamically using machine language techniques to classify one or more users into the interest areas. In an exemplary embodiment of the present invention, the rule may comprise classifying the users identified as having interest in pets into the interest area “pet owner”. Further, ranks are assigned to the interest areas of the users on the basis of the classification.

At step 712, personalization information is determined. In various embodiments of the present invention, predetermined rules are applied based on the assigned ranks to determine personalization information of the user. In an embodiment of the present invention, the ranking information stored in the central data repository may be analyzed to determine personalization level for customizing the user experience. Thus, based on the ranking, the user's interest level in a particular area can be gauged. In the example mentioned above, it can be gauged that the user is more interested in ‘sports’ as compared to ‘food’. Predetermined rules, may then be applied for determining personalization information of the user.

Examples of rules may include the following: Rank=2 may imply that the user is interested in a particular topic and can be targeted for buying subscription to a package containing more information on the topic. Rank=3 may imply that in addition to everything that can be done for rank=2, features and applications may be reordered so as to ease the user's access. Rank=4 may imply that in addition to everything that can be done for rank=3, the user may be branded as having passion for information relating to certain topic and so the user experience may be defined in a manner that makes the user access related information with least possible browsing.

At step 714, a customized application is rendered on the different device types based on the personalization and configuration information. In various embodiments of the present invention, user interface layout is adapted across the various device types based on the configuration information and user behavior/activity determined based on the ranking. The user interface layout is, thus, altered as per the user's subscription profile and ‘user history’ i.e. ranking of past requests and provides a customized user experience to the user.

The present invention may be implemented in numerous ways including as a apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A method for providing a customized application on different requesting device types of a user, the method comprising the steps of:
receiving requests made by the user using the different device types over multiple communication channels;
assigning a rank to the user based on requests received and one or more rules;
determining personalization information based on the ranking; and
rendering a customized application on the different device types based on the personalization information and configuration information stored in a central data repository, wherein the configuration information is related to the application and features thereof based on the user's subscription profile.

2. The method of claim 1 further comprising the step of storing the requests in the central data repository.

3. The method of claim 1 further comprising the step of monitoring requests made by the user using the different device types over multiple communication channels.

4. The method of claim 1, wherein the multiple communication channels comprises at least one of: internet, wireless network capable of data exchange such as General Packet Radio Service (GPRS), Enhanced Data for Global Evolution (EDGE), High-Speed Packet Access (HSPA), Evolution Data Optimized (EvDO), Long-Term Evolution (LTE), Worldwide Interoperability for Microwave Access (WiMAX), Wireless Fidelity (WiFi), High Speed digital cable, Direct to Home (DTH) TV and Internet Protocol Television (IPTV) and any other type of over the air wireless network.

5. The method of claim 1, wherein the different requesting device types comprises at least one of: Television (TV), Mobile Phone and Personal Computer (PC).

6. The method of claim 1, wherein the requests comprises at least one of: browsing a website from a PC, surfing channels in a TV and making Short Messaging Service (SMS) requests using a mobile phone.

7. The method of claim 1, wherein the application comprises any one of a web-based application, a mobile-based application, a television-based application, gaming application etc.

8. The method of claim 1, wherein the configuration information comprises information related to the application or features thereof based on user and service provider preferences.

9. The method of claim 1, wherein the configuration information comprises information related to reordering of application and features thereof based on user's usage information.

10. The method of claim 1, wherein the step of assigning a rank to the user based on requests received and one or more rules comprises:
categorizing the requests into a plurality of interest areas;
assigning a rank to each interest area; and
incrementing the rank based on determination of the number of times requests are made corresponding to each interest area in a predetermined time period.

11. The method of claim 10, wherein the predetermined time period comprises requests made by the user within six hours, twelve hours, twenty four hours etc.

12. The method of claim 10 further comprising the step of tagging the user to a specific interest area.

13. The method of claim 1 further comprising the steps of :
identifying access patterns of one or more users;
determining one or more rules dynamically using machine learning techniques to classify the one or more users into one or more interest areas based on the access patterns; and
assigning a rank to each user based on the classification.

14. The method of claim 13, wherein the step of identifying access patterns of one or more users comprises using information from at least one of: web server logs, TV viewing information and mobile phone usage information related to the one or more users.

15. The method of claim 13, wherein the step of determining one or more rules dynamically using machine learning techniques to classify the users into one or more interest areas based on the access patterns comprises identifying users with any of similar: web server log information, TV viewing information and mobile phone usage information.

16. The method of claim 1, wherein the step of determining personalization information comprises applying predetermined rules based on the ranking to determine level of personalization of the user.

17. The method of claim 1, wherein the step of rendering a customized application on the different device types based on the personalization and configuration information comprises generating a customized user interface layout.

18. A system for providing a customized application on different requesting device types of a user, the system comprising:
an Adaptive Application & Feature Configuration (AAFC) module configured to facilitate maintaining configuration information related to the applications and features thereof based on the users subscription profile and further configured to rank the user based on requests made by the user using different device types and one or more rules; and
a Service Delivery & User Interface Rendering Platform (SDUIRP) in communication with the AAFC configured to determine personalization information of the user based on the ranking and provide a customized application to the user on different requesting device types based on the personalization and configuration information.

19. The system of claim 18, wherein the AAFC comprises an administrator user interface configured to receive configuration information related to the applications and features thereof and further configured to store the configuration information in a central data repository.

20. The system of claim 18, wherein the AAFC comprises a user profile module configured to receive and process requests made by the user using the different device types and further configured to store the request in a central data repository.

21. The system of claim 18, wherein the AAFC comprises a ranking engine configured to:
categorize the requests into a plurality of interest areas;
assign a rank to each interest area; and
increment the rank based on determination of the number of times requests are made corresponding to each interest area in a predetermined time period.

22. The system of claim 21, wherein the predetermined time comprises requests made by the user within six hours, twelve hours, twenty four hours etc.

23. The system of claim 18, wherein the AAFC comprises a ranking engine which further comprises a smart analytics engine configured to facilitate the ranking engine to:
identify access patterns of one or more users;
determine one or more rules dynamically using machine learning techniques to classify the users into one or more interest areas based on the access patterns; and
assign a rank to each user based on the classification.

24. The system of claim 18, wherein the AAFC comprises a ranking engine which further comprises a smart analytics engine configured to facilitate the ranking engine to:
analyze one or more user requests across the different device types at predetermined intervals of time;
add new interest areas to an existing list of interest areas dynamically using machine learning techniques for classifying similar users from amongst the one or more users into the new interest areas based on the analysis; and
assign a rank to each user based on the classification.

25. The system of claim 24, wherein the one or more users correspond to any of existing users and new users.

26. The system of claim 24, wherein the smart analytics engine is further configured to refine one or more fixed broad interest areas into specific interest areas or merge one or more fixed specific interest areas into one or more broad interest areas based on the analysis.

27. The system of claim 24, wherein the smart analytics engine is further configured to:
analyze one or more user requests across the different device types of the one or more users; and
classify similar users from amongst the one or more users into one or more fixed interest areas.

28. The system of claim 18, wherein the SDUIRP is further configured to:
monitor the requests made by the user over multiple communication channels; and
transmit the requests to the AAFC.

29. The system of claim 18, wherein the SDUIRP is further configured to provide information related to the user and the type of requesting device to the AAFC.

30. The system of claim 18 further comprising an applications module configured to send the configuration information to the AAFC electronically in an XML file.

31. The system of claim 18 further comprising a business logic layer configured to facilitate the SDUIRP to retrieve the configuration information and ranking information from a central data repository.

32. The system of claim 18, wherein the different requesting device types comprises Television (TV), Mobile Phone and Personal Computer (PC).

33. The system of claim 18, wherein the different requesting device types further comprises at least one of: desktop or laptop with access to internet, high end mobile devices capable of exchanging data, Open Cable Application Platform (OCAP), Enhanced TV Binary Interchange Format (EBIF) based digital cable TV, Direct to Home (DTH) TV and any IPTV based system.
